(19) United States
(12) Patent Application Publication
(10) Pub. No.: US 2016/0238483 A1
(43) Pub. Date: Aug. 18, 2016

(54) OPTICAL FIBER CABLE MONITORING APPARATUS AND OPTICAL FIBER CABLE MONITORING METHOD USING DUAL LIGHT SOURCE

(71) Applicant: ELECTRONICS AND TELECOMMUNICATIONS RESEARCH INSTITUTE, Daejeon-si (KR)

(72) Inventors: Seung IL MYONG, Daejeon-si (KR); Jyung Chan LEE, Daejeon-si (KR); Hun Sik KANG, Daejeon-si (KR); Jong Hyun LEE, Daejeon-si (KR)

(21) Appl. No.: 15/042,670

(22) Filed: Feb. 12, 2016

(30) Foreign Application Priority Data
Feb. 13, 2015 (KR) 10-2015-0022660

(51) Int. Cl. G01M 11/00; G02B 6/293

(52) U.S. Cl. CPC G01M 11/3154; G02B 6/293

(57) ABSTRACT

Disclosed is an optical fiber cable monitoring apparatus using a dual light source. The optical fiber cable monitoring apparatus includes: an optical transmitter configured to comprise a first light source and a second light source, which output light of different wavelengths, and to operate the first light source and the second light source to propagate first probe light and second probe light to an optical fiber cable; and an optical receiver configured to comprise a first light receiving module and a second light receiving module, each receiving first reflected light and second reflected light which are reflected from the optical fiber cable.

### CROSS-REFERENCE TO RELATED APPLICATION(S)

This application claims priority from Korean Patent Application No. 10-2015-0022660, filed on Feb. 13, 2015, in the Korean Intellectual Property Office, the entire disclosure of which is incorporated herein by reference for all purposes.

### BACKGROUND

1. Field

The following description generally relates to an optical fiber cable monitoring apparatus and an optical fiber cable monitoring method, and more particularly to a technology for monitoring an optical fiber cable by using a dual light source.

2. Description of the Related Art

Wired or wireless communication providers and cable network providers are scheduled to provide subscribers with several gigabit bandwidth in 2020 for services of large contents, such as UHDTV or 3D-TV. Accordingly, with the increased cost of terminals provided to subscribers, the network cost is expected to increase, and network providers are trying to reduce a total cost, including the cost for network installation and maintenance and the like, by extending a distance between base stations or by increasing the number of subscribers managed by each base station. However, as the distance between base stations is extended, and the number of subscribers to be managed is increased, the number of optical fiber cables installed from the base stations to subscribers is also increased, leading to problems in that in case of failures, such as cutting of optical fiber cables, the number of repairs and the cost for repair services are increased, a location where a failure occurs in an optical fiber cable may not be accurately identified, and the failure may not be accurately diagnosed.

In order to identify and diagnose a failure location on an optical fiber cable, an optical transmitter and an optical receiver are required to be equipped with a high power light source, a narrow-band pulse generator, a low noise amplifier, a receiver having a wide dynamic range, linear amplification gain, and the like. Specifically, a high split ratio (split ratio of 1:64 or higher) requires a device with an ultrahigh power light source, which is expensive such that an operating expense (OPEX) is increased. Accordingly, there is a need for low-cost devices or low-cost optical equipment in the Optical Time-Domain Reflectometer (OTDR). Korean Laid-open Patent Publication No. 10-2003-0023305 discloses an apparatus for monitoring a WDM-PON optical fiber cable by using the OTDR.

### SUMMARY

Provided is an optical fiber cable monitoring apparatus and an optical fiber cable monitoring method using a dual light source, which enables long-distance and high-precision monitoring by the optical fiber cable monitoring apparatus without problems caused by a high-cost, high-power, and high-speed signal, i.e., a narrow-band optical pulse signal.

In one general aspect, there is provided an optical fiber cable monitoring apparatus, including: an optical transmitter configured to comprise a first light source and a second light source, which output light of different wavelengths, and to operate the first light source and the second light source to propagate first probe light and second probe light to an optical fiber cable; and an optical receiver configured to comprise a first light receiving module and a second light receiving module, each receiving first reflected light and second reflected light which are reflected from the optical fiber cable.

The optical transmitter may simultaneously operate the first light source and the second light source by using one electric signal, so that the first light source and the second light source have identical output characteristics.

The optical receiver may differentiate pulse signals generated by photoelectrically converting the first reflected light and the second reflected light, and may estimate a reflection location based on the differentiation.

The optical receiver may calculate a loss value on the optical fiber cable based on an intensity of each of the photoelectrically converted pulse signals, and may determine whether there is a failure in the optical fiber cable based on the calculated loss value.

The apparatus may further include an optical coupler configured to be optically connected to the optical fiber cable to couple the first probe light and the second probe light, and to propagate the coupled probe light to the optical fiber cable.

The apparatus may further include a wavelength splitter, in which in response to the probe light, coupled by the optical coupler and propagated to the optical fiber cable, being reflected from the optical fiber cable, the wavelength splitter may split the reflected light into the first reflected light and the second reflected light, and may input the first reflected light and the second reflected light into the first light receiving module and the second light receiving module respectively.

In another general aspect, there is provided an optical fiber cable monitoring method, including: operating a first light source and a second light source, which output light of different wavelengths; propagating first probe light and second probe light, output by the operation of the first light source and the second light source, to an optical fiber cable; and receiving first reflected light and second reflected light, reflected from the optical fiber cable, at a first light receiving module and a second light receiving module respectively.

The operation of the first light source and the second light source may include simultaneously operating the first light source and the second light source by using one electric signal, so that the first light source and the second light source have identical output characteristics.

The method may further include: differentiating pulse signals generated by photoelectrically converting the first reflected light and the second reflected light; and estimating a reflection location based on the differentiation.

The method may further include: calculating a loss value on the optical fiber cable based on an intensity of each of the photoelectrically converted pulse signals; and determining whether there is a failure in the optical fiber cable based on the calculated loss value.

The method may further include: coupling the first probe light and the second probe light, which have different wavelengths from each other and are output from the first light source and the second light source respectively; and propagating the coupled probe light to the optical fiber cable.

The method may further include, in response to the probe light, propagated to the optical fiber cable, being reflected from the optical fiber cable, splitting the reflected light into the first reflected light and the second reflected light.

### BRIEF DESCRIPTION OF THE DRAWINGS

FIG. 1 is a diagram illustrating an optical fiber cable monitoring apparatus according to an embodiment.

FIG. 2A is a diagram illustrating output characteristics of a dual optical transmitter according to an embodiment.

FIG. 2B is a diagram illustrating an example of an optical fiber cable according to an embodiment.

FIG. 3 is a diagram illustrating output characteristics of an optical receiver and location estimation performed by the optical receiver according to an embodiment.

FIG. 4 is a flowchart illustrating an optical fiber cable monitoring method according to an embodiment.

### DETAILED DESCRIPTION

Details of other embodiments are included in the following detailed description and drawings. Advantages and features of the present invention, and a method of achieving the same will be more clearly understood from the following embodiments described in detail with reference to the accompanying drawings. Throughout the drawings and the detailed description, unless otherwise described, the same drawing reference numerals will be understood to refer to the same elements, features, and structures.

Hereinafter, the optical fiber cable monitoring apparatus and method using a dual light source will be described with reference to the accompanying drawings.

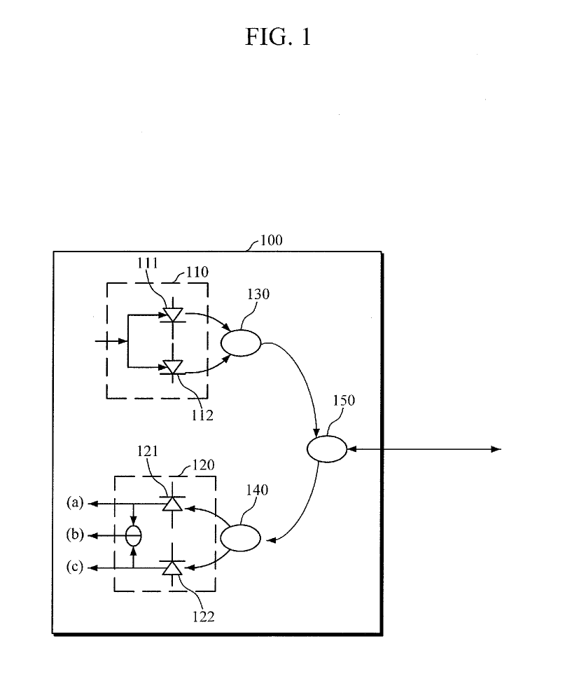

FIG. 1 is a diagram illustrating an optical fiber cable monitoring apparatus according to an embodiment.

Referring to FIG. 1, the optical fiber cable monitoring apparatus 100 includes an optical transmitter 110 and an optical receiver 120.

In one exemplary embodiment, the optical transmitter 110 may include a dual light source, i.e., a first light source 111 and a second light source, as illustrated in FIG. 1, in which the first light source 111 and the second light source 112 may output optical signals having different wavelengths.

The optical transmitter 110 operates the first light source 111 and the second light source 112 to output a first probe light and a second probe light, and to propagate the first probe light and the second probe light to an optical fiber cable.

In one exemplary embodiment, the optical transmitter 110 may operate the first light source 111 and the second light source 112 at the same time by using one electric signal, so that the first light source 111 and the second light source 112 may have the same output characteristics.

The first probe light output from the first light source 111 and the second probe light output from the second light source 112 may be optical signals having different wavelengths.

The optical receiver 120 may receive reflected light, which is a probe light that has been propagated to an optical fiber cable and is reflected back from the optical fiber cable.

In one exemplary embodiment, the optical receiver 120 may include: a first light receiving module 121 that receives first reflected light having a wavelength corresponding to the first probe light output from the first light source 111; and a second light receiving module 122 that receives second reflected light having a wavelength corresponding to the second probe light output from the second light source 112.

The optical receiver 120 photoelectrically converts the first reflected light and the second reflected light which are received by the first light receiving module 121 and the second light receiving module 122 respectively, and differentiates pulse signals generated as a result of the photoelectric conversion, so as to estimate a reflection location based on the differentiation.

Further, the optical receiver 120 may calculate a loss value on an optical fiber cable based on the intensity of each photoelectrically converted pulse signal, and may determine whether there is a failure in the optical fiber cable based on the calculated loss value.

In another exemplary embodiment, the optical fiber cable monitoring apparatus 100 may further include an optical coupler 130, a wavelength splitter 140, and an optical splitter 150.

The optical coupler 130 may couple the first probe light and the second probe light output from the first light source 111 and the second light source 112 respectively, in which the first probe light and the second probe light may have different wavelengths.

The wavelength splitter 140 may split a reflected light signal, which is probe light that has been coupled by the optical coupler 130 and is reflected back from the optical fiber cable, into first reflected light having a wavelength corresponding to the first probe light output from the first light source 111, and second reflected light having a wavelength corresponding to the second probe light output from the second light source 112. Then, the wavelength splitter 140 may input the first reflected light and the second reflected light into the first light receiving module 121 and the second light receiving module 122 respectively. In this case, the wavelength splitter 140 may be a wavelength filter.

The optical splitter 150 may propagate probe light, having the first probe light and the second probe light being coupled to each other, to the optical fiber cable. Further, the optical splitter 150 may input reflected light, which is probe light reflected back from the optical fiber cable, into the wavelength splitter 140. In this case, the optical splitter 150 may be a circulator.

Coupling and splitting of light by the optical coupler 130 and the optical splitter 150, and splitting of a wavelength by the wavelength splitter 140 may be performed by various methods without being limited to any one method.

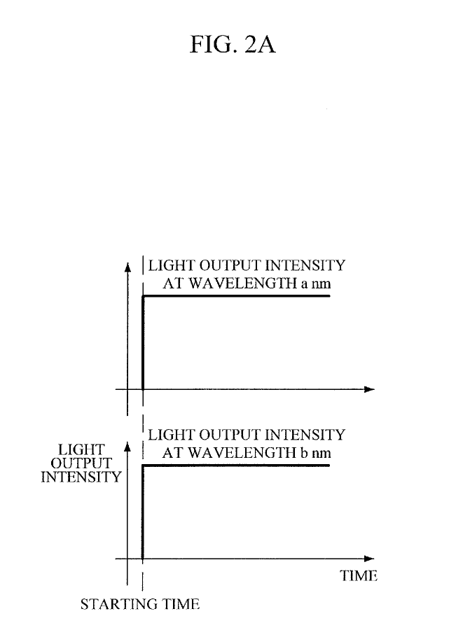

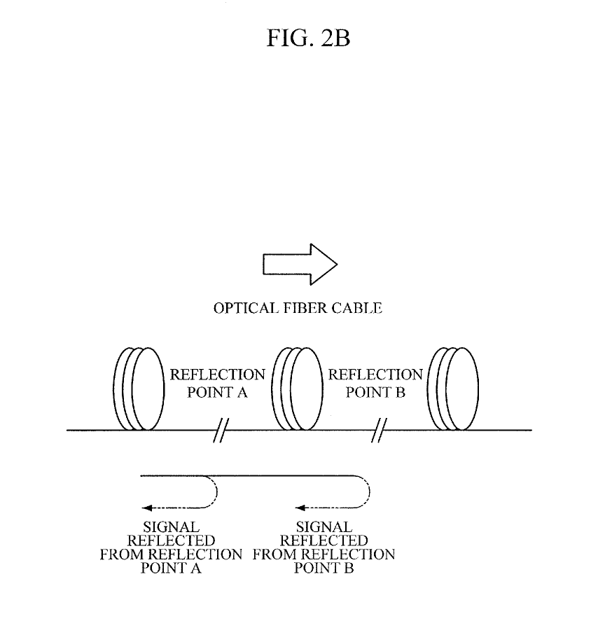

FIG. 2A is a diagram illustrating output characteristics of a dual optical transmitter according to an embodiment.

Referring to FIGS. 1 and 2B, an example of outputting optical output characteristics from a dual light source by using a wide optical pulse width (or a pulse width of ∞) will be described.

Assuming that the first light source 111 outputs light having a wavelength of a nm, the second light source 112 outputs light having a wavelength of b nm, and the first light source 111 and the second light source 112 are operated at the same time by one electric signal, optical output characteristics of the first light source 111 and the second light source 112 according to time are illustrated in FIG. 2A.

Two light sources 111 and 112 are operated by one electric signal, such that the two light sources 111 and 112 may have the same output characteristics.

FIG. 2B is a diagram illustrating signals reflected from two points A and B on an optical fiber cable in the case where there is a failure at the two points A and B. As illustrated in FIG. 2B, probe light, output from the optical transmitter 110, is propagated to the optical fiber cable, the probe light is reflected at the two points A and B where there are failures.

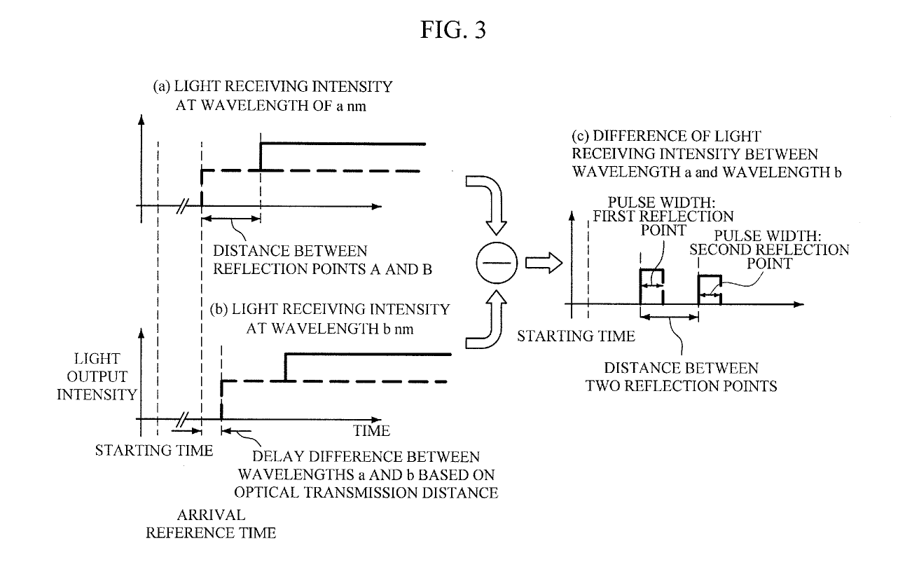

FIG. 3 is a diagram illustrating output characteristics of an optical receiver and location estimation performed by the optical receiver according to an embodiment.

More specifically, by reference to FIGS. 1 and 3, the first light receiving module 121 and the second light receiving module 122 of the optical receiver 120 receive optical signals having different wavelengths, e.g., wavelengths a nm and b nm as illustrated in FIG. 3, which are reflected back from the two reflection points A and B on the optical fiber cable, so as to estimate locations of the reflection points on the optical fiber cable.

FIG. 3 illustrates an example (a) showing an intensity of a nm wavelength, in which the intensity is obtained by receiving and photoelectrically converting the a nm wavelength that has been reflected back from the two reflection points A and B on the optical fiber cable; and an example (b) showing an intensity of b nm wavelength, in which the intensity is obtained by receiving and photoelectrically converting the b nm wavelength that has been reflected back from the two reflection points A and B on the optical fiber cable.

FIG. 3 illustrates stepped graphs showing examples (a) and (b) as a result of wavelengths reflected back from two reflection points A and B. Generally, it is difficult to identify accurate locations of the reflection points based on such characteristics in the form of steps. For this reason, the optical receiver 120 differentiates the two signals, which leads to a result as shown in graph (c) of FIG. 3, so that the reflection location on the optical fiber cable may be estimated more accurately.

The first pulse width in graph (c) of FIG. 3 represents a delay difference between the two wavelengths a nm and b nm at the first reflection point (A), such that the location of the first reflection point may be estimated. Further, the second pulse width represents a delay difference between the two wavelengths a nm and b nm at the second reflection point (B), such that the location of the second reflection point may be estimated.

In addition, a distance between locations of the two reflection points may be estimated based on the interval between the two pulses.

Moreover, a loss value and the like on the optical fiber cable may be calculated by using intensities of two pulses, and an intensity difference between the two pulses.

As described above, by using a dual light source having different wavelengths, locations of reflection points on the optical fiber cable may be easily estimated, and a distance between locations of the reflection points may be easily measured.

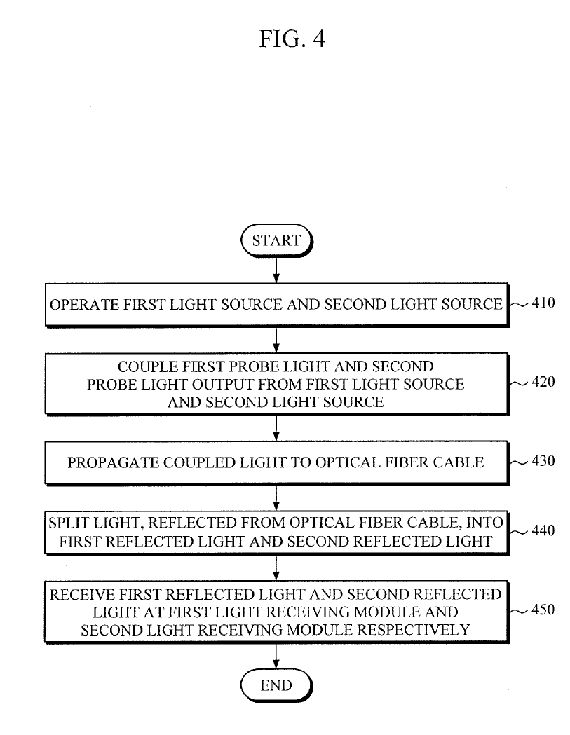

FIG. 4 is a flowchart illustrating an optical fiber cable monitoring method according to an embodiment.

The optical fiber cable monitoring method illustrated in FIG. 4 may be a method performed by an optical fiber cable monitoring apparatus that includes a dual light source.

The optical fiber cable monitoring apparatus may include: an optical transmitter that includes a first light source and a second light source; and an optical receiver that includes a first light receiving module, receiving reflected light which corresponds to a wavelength of the first light source, and a second light receiving module, receiving reflected light which corresponds to a wavelength of the second light source.

Referring to FIG. 4, in the optical fiber cable monitoring method, the optical transmitter operates the first light source and the second light source in 410.

The optical transmitter may operate the first light source and the second light source at the same time as one electric signal so that the first light source and the second light source may have the same output characteristics. FIG. 2A illustrates an example where the first light source and the second light source are operated at the same time, such that light of wavelength a nm and light of wavelength b nm, each output from the first light source and the second light source, may have the same output characteristics.

Then, an optical coupler couples, in 420, first probe light and second probe light, each output from the first light source and the second light source of the optical transmitter, and propagates the coupled probe light to the optical fiber cable in 430.

Subsequently, a wavelength splitter or a wavelength filter splits reflected light, which has been reflected back from the optical fiber cable, into first reflected light and second reflected light in 440.

FIG. 2B illustrates an example where probe light propagated on the optical fiber cable is reflected back from two reflection points A and B, in which the probe light is reflected at the two reflection points A and B with a predetermined distance therebetween.

In this case, the wavelength splitter may split reflected light, which has been reflected from the optical fiber cable, into first reflected light corresponding to a wavelength of the first probe light output from the first light source, and second reflected light corresponding to a wavelength of the second probe light output from the second light source.

Then, the first light receiving module of the optical receiver may receive the first reflected light corresponding to the wavelength of the first light source, and the second light receiving module may receive the second reflected light corresponding to the wavelength of the second light source in 450.

As described above with reference to FIG. 3, the optical receiver photoelectrically converts the first reflected light and the second reflected light received by the first light receiving module and the second light receiving module respectively, and may differentiate pulse signals generated as a result of the photoelectric conversion. Subsequently, a reflection location may be estimated by using differentiation results. Further, the optical receiver may calculate a loss value on the optical fiber cable based on the intensity of a photoelectrically converted pulse signal.

FIG. 3 illustrates stepped graphs showing examples (a) and (b) as a result of wavelengths reflected back from two reflection points A and B. Generally, it is difficult to identify accurate locations of the reflection points based on such characteristics in the form of steps. For this reason, the optical receiver differentiates the two signals, which leads to a result as shown in graph (c) of FIG. 3, so that the reflection location on the optical fiber cable may be estimated more accurately.

For example, the first pulse width in graph (c) of FIG. 3 represents a delay difference between the two wavelengths a nm and b nm at the first reflection point (A), such that the location of the first reflection point may be estimated. Further, the second pulse width refers to a delay difference between the two wavelengths a nm and b nm at the second reflection point (B), such that the location of the second reflection point may be estimated. In addition, a distance between locations of the two reflection points may be estimated based on the interval between the two pulses. Moreover, a loss value and the like on the optical fiber cable may be calculated by using intensities of two pulses, and an intensity difference between the two pulses.

In the general optical fiber cable monitoring method, an optical fiber cable is monitored by using a light source having a constant pulse width, in which a high-speed light source having a narrow pulse width is used to improve precision. However, the general method has a problem in that average optical power is low, thus requiring a high power light source for long-distance measurement. Such high-speed and high-power light source is a main reason for the increased cost of an optical fiber cable monitoring apparatus.

However, in the exemplary embodiments described above, a location of a reflection point may be estimated accurately by using only a low-speed light source and an optical receiver, such that an optical module may be used in a cost-efficient manner. Further, various types of information may be easily estimated and calculated by processing results obtained by receiving two wavelengths.

The present disclosure provides optical fiber cable monitoring by using a dual light source, which enables long-distance and high-precision monitoring by the optical fiber cable monitoring apparatus without problems caused by a high-cost, high-power, and high-speed signal, thereby enabling high precision even with a low-cost and wideband pulse width.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims. Further, the above-described examples are for illustrative explanation of the present invention, and thus, the present invention is not limited thereto.

What is claimed is:

1. An optical fiber cable monitoring apparatus, comprising:
an optical transmitter configured to comprise a first light source and a second light source, which output light of different wavelengths, and to operate the first light source and the second light source to propagate first probe light and second probe light to an optical fiber cable; and
an optical receiver configured to comprise a first light receiving module and a second light receiving module, each receiving first reflected light and second reflected light which are reflected from the optical fiber cable.

2. The apparatus of claim 1, wherein the optical transmitter simultaneously operates the first light source and the second light source by using one electric signal, so that the first light source and the second light source have identical output characteristics.

3. The apparatus of claim 1, wherein the optical receiver differentiates pulse signals generated by photoelectrically converting the first reflected light and the second reflected light, and estimates a reflection location based on the differentiation.

4. The apparatus of claim 3, wherein the optical receiver calculates a loss value on the optical fiber cable based on an intensity of each of the photoelectrically converted pulse signals, and determines whether there is a failure in the optical fiber cable based on the calculated loss value.

5. The apparatus of claim 1, further comprising an optical coupler configured to be optically connected to the optical fiber cable to couple the first probe light and the second probe light, and to propagate the coupled probe light to the optical fiber cable.

6. The apparatus of claim 5, further comprising a wavelength splitter, wherein in response to the probe light, coupled by the optical coupler and propagated to the optical fiber cable, being reflected from the optical fiber cable, the wavelength splitter splits the reflected light into the first reflected light and the second reflected light, and inputs the first reflected light and the second reflected light into the first light receiving module and the second light receiving module respectively.

7. An optical fiber cable monitoring method, comprising:
operating a first light source and a second light source, which output light of different wavelengths;
propagating first probe light and second probe light, output by the operation of the first light source and the second light source, to an optical fiber cable; and
receiving first reflected light and second reflected light, reflected from the optical fiber cable, at a first light receiving module and a second light receiving module respectively.

8. The method of claim 7, wherein the operation of the first light source and the second light source comprises simultaneously operating the first light source and the second light source by using one electric signal, so that the first light source and the second light source have identical output characteristics.

9. The method of claim 7, further comprising:
differentiating pulse signals generated by photoelectrically converting the first reflected light and the second reflected light; and
estimating a reflection location based on the differentiation.

10. The method of claim 9, further comprising:
calculating a loss value on the optical fiber cable based on an intensity of each of the photoelectrically converted pulse signals; and
determining whether there is a failure in the optical fiber cable based on the calculated loss value.

11. The method of claim 7, further comprising coupling the first probe light and the second probe light, which have different wavelengths from each other and are output from the first light source and the second light source respectively; and
propagating the coupled probe light to the optical fiber cable.

12. The method of claim 11, further comprising, in response to the probe light, propagated to the optical fiber cable, being reflected from the optical fiber cable, splitting the reflected light into the first reflected light and the second reflected light.
